(19) United States
(12) Patent Application Publication
(10) Pub. No.: US 2026/0189501 A1
(43) Pub. Date: Jul. 2, 2026

(54) PRECALCULATED ROUTING INFORMATION IN A COHERENT MESH NETWORK

(71) Applicant: Akeana, Inc., Santa Clara, CA (US)

(72) Inventors: Yogesh Shamkant Thombre, Pleasanton, CA (US); Madhavi Kondapaneni, Cupertino, CA (US); Ayesha Zahid, Rawalpindi (PK)

(73) Assignee: Akeana, Inc., Santa Clara, CA (US)

(21) Appl. No.: 19/550,424

(22) Filed: Feb. 26, 2026

Related U.S. Application Data
(63) Continuation-in-part of application No. 19/313,925, filed on Aug. 29, 2025.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.
(60) Provisional application No. 63/983,964, filed on Feb. 16, 2026.

(51) Int. Cl. H04L 45/00; G06F 12/0815; H04L 45/302; H04L 49/109

(52) U.S. Cl. CPC H04L 45/54; G06F 12/0815; H04L 45/302; H04L 49/109

(57) ABSTRACT

A network is accessed. The network comprises a plurality of tiles. Each tile in the plurality of tiles includes a mesh switching unit. A communication packet is received by a first tile within the plurality of tiles. The communication packet specifies a target tile within the network. The first tile and the target tile are not adjacent within the network. The communication packet includes a first routing. The first routing includes a first intermediate tile within the plurality of tiles. A second routing is determined by the first tile. The second routing is based on a second intermediate tile within the plurality of tiles. The communication packet is sent by the first tile to the first intermediate tile. The sending includes the second routing. The process continues until the communication packet reaches the target tile within the network.

### RELATED APPLICATIONS

This application claims the benefit of U.S. provisional patent applications “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, “Matrix Multiply Acceleration Based On A Static Partitioning History Table” Ser. No. 63/914,824, filed Nov. 10, 2025, “Hierarchical Performance-Based Scheduler For Data Center Workloads” Ser. No. 63/941,793, filed Dec. 16, 2025, and “Memory Latency Hiding With A Memory Accelerator” Ser. No. 63/983,964, filed Feb. 16, 2026.

This application is also a continuation-in-part of U.S. patent application “Adaptive SOC Routing With Distributed Quality-Of-Service Agents” Ser. No. 19/313,925, filed Aug. 29, 2025, which claims the benefit of U.S. provisional patent applications “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, and “In-Order Multithreading With Pipeline Flush And Instruction Replay” Ser. No. 63/870,916, filed Aug. 27, 2025.

Each of the foregoing applications is hereby incorporated by reference in its entirety.

### FIELD OF ART

This application relates generally to computer processors and more particularly to precalculated routing information in a coherent mesh network.

### BACKGROUND

Computer processors are used in a vast range of applications across industries. Some of the most common applications include personal computing and consumer electronic devices. These devices can include laptop and desktop computers, smartphones and tablet computers, smart TVs and streaming devices, gaming consoles, wearable computing devices such as a smartwatch, and more. Another common application for processors is artificial intelligence (AI) and machine learning. Machine learning (ML) is computationally demanding, particularly in certain phases and types of models. For example, backpropagation and gradient descent can involve calculating derivatives and adjusting billions of weights. Hyperparameter tuning can involve techniques such as grid search, random search, and Bayesian optimization that can involve training the same model multiple times with different settings and can require ample processing power to perform in a timely manner. AI enabled applications such as speech recognition, virtual assistance, and computer vision applications can also require extensive processing power. For example, computer vision applications can demand significant computational power as large volumes of image and video data must be processed in real time. Computer vision operations such as resizing and scaling, filtering, color space conversion, edge detection, and histogram equalization can require extensive computations. Computer vision can be computationally expensive because it relies heavily on operations such as matrix multiplications, convolution operations, feature extraction, and deep learning inference.

Yet another growing area for processors is industrial and embedded systems. This can include applications such as automation and robotics. IoT (Internet of Things) devices enable technologies such as smart home systems, medical sensors, smart meters, and more. These systems can also demand significant processing power. Other areas, such as cloud computing, cryptography, healthcare, and augmented reality, continue to drive advancements in processor technology. Additionally, technologies such as AI, cryptography, blockchain, and real-time analytics are pushing the limits of current processors. In particular, blockchain and cryptography applications can make extensive use of hashes. Computing hashes can be computationally intensive, depending on the hashing algorithm and the number of hashes that need to be computed. While some simple hashing algorithms (like MD5 or SHA-1) are relatively fast, cryptographic hash functions (such as SHA-256 or Argon2) are deliberately designed to be computationally expensive for security reasons. In applications such as blockchain mining, password hashing, or digital signatures, computing hashes at high rates can require massive computational resources.

As computing demands continue to grow, faster processors play a crucial role in enabling new technologies, improving efficiency, and enhancing user experiences. More capable processors enable quicker processing of computations, software execution, and data analysis. They also improve the ability to run multiple applications smoothly without slowdowns. Furthermore, improving processor speed is important for applications such as video conferencing, cloud computing, and gaming. For example, faster processors can allow games to run at higher FPS (frames per second), leading to smoother rendering. Faster processors also reduce latency, which can be beneficial for competitive gaming and VR (virtual reality) experiences. Other important areas, such as weather forecasting, medical research, aerospace design, and others, can also benefit from faster processors. In summary, faster processors drive progress in nearly every field of technology and are fundamental to improving the performance, efficiency, and capabilities of modern computing systems.

### SUMMARY

Mesh processors can be a type of multi-core architecture where one or more processer cores can be arranged in a grid-like structure, enabling efficient parallel processing and the capability of cores to communicate with each other. The cores can reside in tiles, where each tile includes processors, memory, communication interfaces, cache coherency blocks, peripherals, and so on. Cores that are adjacent to one another can communicate with each other directly. Cores that are separated from each other by one or more intermediate tiles can communicate by relaying information to an adjacent tile, which in turn passes the information to another adjacent tile, until the information reaches the target tile, which is the intended destination for the information. Data can travel through the shortest path to its destination, reducing latency. If too much network traffic appears on the shortest path, another path can be chosen to minimize delays, buffering, arbitration, and so on. The mesh topology can help to reduce data transfer latency, improving overall system bandwidth.

Techniques for providing precalculated routing information in a coherent mesh network are disclosed. A network of tiles is accessed. Each tile includes a mesh switching unit. A communication packet is received by a first tile that specifies a non-adjacent target tile within the network. One or more intermediate tiles can be in the communication path between the first tile and the target tile. The communication packet includes a first routing that includes a first intermediate tile. The first tile determines a routing that is executed by the first intermediate tile. The first intermediate tile determines a routing that is executed by a subsequent tile. The process continues until the communication packet reaches the target tile within the network.

A processor-implemented method for sharing data is disclosed comprising: accessing a network, wherein the network comprises a plurality of tiles, wherein each tile in the plurality of tiles includes a mesh switching unit; receiving, by a first tile within the plurality of tiles, a communication packet, wherein the communication packet specifies a target tile within the network, wherein the first tile and the target tile are not adjacent within the network, and wherein the communication packet includes a first routing, wherein the first routing includes a first intermediate tile within the plurality of tiles; determining, by the first tile, a second routing, wherein the second routing is based on a second intermediate tile within the plurality of tiles; and sending, by the first tile, to the first intermediate tile, the communication packet, wherein the sending includes the second routing.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for precalculated routing information in a coherent mesh network.

FIG. 2 is a flow diagram for transferring a packet.

FIG. 3 is a block diagram of an M×N mesh.

FIG. 4 is an illustration of routing.

FIG. 5 is an illustration of looking up routing information.

FIG. 6 is an example lookup table.

FIG. 7 is a block diagram of a switching unit.

FIG. 8 is a block diagram of a switching unit with a quality-of-service (QoS) agent.

FIG. 9 is a design flow for semiconductor logic generation.

FIG. 10 is a system diagram for precalculated routing information in a coherent mesh network.

### DETAILED DESCRIPTION

The continued need for higher and higher levels of performance drive advanced designs of processors, accelerators, application specific integrated circuits (ASICs), system-on-chips (SoCs), switching chips, and so on. Advances in artificial intelligence (AI) and machine learning are especially computationally demanding, both in training and running inferences. For example, backpropagation and gradient descent can involve calculating derivatives and adjusting billions of weights. Hyperparameter tuning can involve techniques such as grid search, random search, and Bayesian optimization that can involve training the same model multiple times with different settings and can require ample processing power to perform in a timely manner. AI enabled applications such as speech recognition, virtual assistance, and computer vision applications can also require extensive processing power. As a result, today's SoCs can include tens of billions of transistors and many processors. Even with such processing power, the sheer size of today's workloads must often be split between processors, SoCs, accelerators, and so on. Thus, harnessing the power of a system requires efficient communication between processor cores, SoCs, chips, and so on.

Bottlenecks in sending information between processor cores within an SoC, between SoCs, and so on can become a significant performance limitation. For example, an SoC may comprise one or more tiles, each of which can include one or more processor cores, memory, communication interfaces, cache coherency blocks, peripherals, and so on. The tiles can be coupled in a mesh, or grid, topology. It is critical that tiles can efficiently exchange data within the SoC with both adjacent and non-adjacent tiles. Routing mechanisms between these elements can help to reduce communication bottlenecks, but inefficiencies often still arise, causing delays in information sharing between tiles, or even stalls as one tile must wait for data to be received from a sending tile. Furthermore, in some cases, tasks may originate from different parts of the mesh, requiring data to be sent over long distances to non-adjacent cores for processing. Further, long routes must be carefully routed so that the need for buffering, arbitration, and so on can be minimized. While direct communication with adjacent tiles is simple, reaching distant tiles can be problematic, requiring more complex routing calculations that can make timing difficult to meet. Without proper routing mechanisms, latency, congestion, and inefficiencies can degrade overall system performance, making processor operation less effective.

Disclosed implementations address the aforementioned routing challenges by providing precalculated routing information in a coherent mesh network. For communication between non-adjacent tiles within a network, tiles can determine a routing that a next tile implements, the next tile can determine a routing that a subsequent tile implements, and so on. In this way, tiles compute an “N+1” routing by computing routing information to be used by the next tile in a route. The “N+1” routing serves to offload the routing computations from the tile that actually performs the routing and can enable routing determination to be performed in parallel with other tasks. Accordingly, disclosed implementations can enable processor clock speeds to be increased by exploiting the efficiency obtained by utilizing the disclosed “N+1” routing techniques.

A network is accessed. The network comprises a plurality of tiles. Each tile includes a mesh switching unit. A first tile receives a communication packet which specifies a target tile within the network. The first tile and the target tile are not adjacent. Each tile can include a lookup table (LUT), which includes one or more routes from each tile to the target tile. Each LUT can be programmable. The communication packet includes a first routing which includes a first intermediate tile within the plurality of tiles. The first tile determines a second routing based on a second intermediate tile within the plurality of tiles. The determining can include finding the second routing in the LUT. The first tile sends the communication packet to the first intermediate tile. The communication packet includes the second routing.

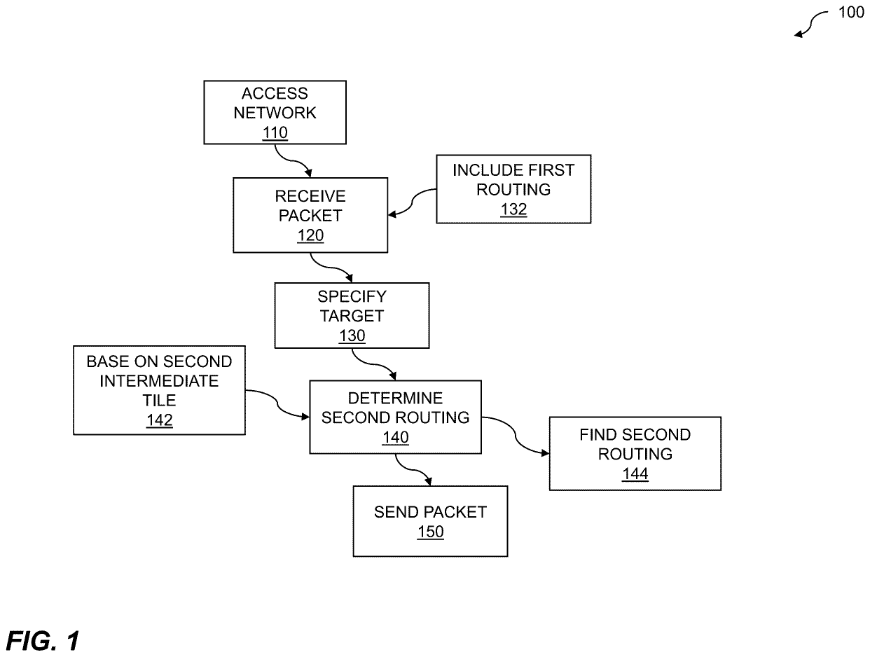

FIG. 1 is a flow diagram for precalculated routing information in a coherent mesh network. The flow 100 includes accessing a network 110. In embodiments, the network is within a system-on-chip (SoC). The network can be within a processor core, a board, a rack, a data center, and so on. The network includes a plurality of coherent tiles. The tiles can be arranged in an M×N mesh topology. In some implementations, the network of coherent tiles can be implemented on a system-on-chip (SoC). The tiles can include multicore processors, bus interfaces, caches, switches, and the like. The elements at any point in the mesh can comprise coherent elements, where each element includes the same view of memory. Each tile in the plurality of tiles includes a mesh switching unit. A mesh switching unit can include logic and functions for directing communications from one tile to another tile within the mesh. The mesh switching unit can direct communications to other tiles within the mesh to the north, south, east west, and so on. The coherent tiles can support pipelined execution, Out-of-Order (OoO) execution, memory coherency, and so on. The SoC can include a network-on-chip (NoC). In embodiments, the network comprises a network-on-chip (NoC), wherein the NoC includes an M×N mesh topology, wherein the M×N mesh topology includes a tile at each point of the M×N mesh topology. In some embodiments, each tile in the plurality of tiles is coherent. In further embodiments, at least one tile in the plurality of tiles includes a cache coherency block (CCB).

The flow 100 includes receiving, by a first tile within the plurality of tiles, a communication packet 120. The packet can include a payload (data), header data that can include routing information, and so on. In the flow 100, the communication packet specifies a target tile 130 within the network. The target tile can be the destination tile for the communication packet. The specifying of the target tile can use a numeric identifier, tile address, tile coordinates, and/or other suitable identifier(s). The target tile, an intermediate tile, or any other tile specified in the communication packet can be within the M×N mesh. In disclosed implementations, M and N may be equal or unequal. As a non-limiting example, M can be 16 and N can be 16. As another non-limiting example, M can be 32 and N can be 16. Other values of M and N are possible in disclosed implementations. The target can be the final tile to which the communication will eventually be sent within the M×N mesh.

The first tile and the target tile are not adjacent within the network. There can be any number of intermediate tiles (or “hops”) between the first tile and the target tile. Thus, communications between the first tile and the target tile can have multiple possible routing paths. The communication packet includes a first routing 132. The first routing includes a first intermediate tile within the plurality of tiles. The first tile can send the communication packet, which can include the payload (data), to the first intermediate tile. Thus, calculation of the routing of the first intermediate tile (which comprises the first hop from the first tile) is not necessary by the first tile. This can enhance timing closure within the first tile since the next immediate route calculation was sent ahead of time (in the communication packet that was received).

The flow 100 includes determining, by the first tile, a second routing 140. Recall that there can be any number of intermediate tiles between the first tile and the target file. In the flow 100, the second routing 144 is based on a second intermediate tile 142 within the plurality of tiles. The second intermediate tile can be a tile on the routing path to the target file after the first intermediate tile. In embodiments, the second intermediate tile comprises the target file. The routing information for the second intermediate tile can be sent by the first tile to the first intermediate tile. In embodiments, the determining is accomplished by a mesh switching unit (MSU). Note that the first intermediate tile does not need to perform the routing calculation to the second intermediate tile. As described above, the routing path for the next tile in the routing path is precalculated by a previous tile in the mesh network. This can enhance timing closure within the MSU and/or other elements of the tile since each tile is sent the next hop in the routing path to the target file.

In embodiments, the first routing and the second routing are based on a static routing algorithm. A static routing algorithm can predefine where each tile sends data such that the data can make its way through the M×N mesh to the target tile. The static algorithm can be optimized to minimize the number of intermediate nodes, to avoid specific nodes, to route around known congested areas within the mesh, and so on. In embodiments, the static routing algorithm is vertical then horizontal. When sending from the first tile to a target tile, a vertical then horizontal static routing algorithm can send data packets vertically in the mesh (e.g., north and south) before sending data packets horizontally in the mesh (e.g., east and west). In other embodiments, the static routing algorithm is horizontal then vertical. Recall that a communication packet can be sent to a tile, such as tile A, which includes the target tile. The communication packet can include the first routing. Also recall that the second routing can be determined by tile A. In embodiments, the static routing algorithm is based on each tile in the plurality of tiles. Thus, when sending to target tile X, tile A can be programmed such that it determines the second routing to include tile G on the routing path to target tile X. Likewise, when sending to target tile Y, tile A can be programmed such that it determines the second routing to include tile H on the routing path to target tile Y. Any combination of programming is possible for all tiles within the mesh network based on the target tile.

In embodiments, each tile within the plurality of tiles includes a lookup table (LUT), wherein the LUT includes one or more routes from each tile to the target tile. The second routing that is determined by the first tile can be based on the LUT. In embodiments, the determining includes finding the second routing in the LUT. The first tile can perform a lookup with the LUT to determine the second routing to send to the first intermediate tile. More than one entry can exist within the LUT for the second routing, based on the target tile. In this case, the first tile can use additional logic to determine which routing path to use. The additional logic can include monitoring traffic on one or more paths to one or more tiles in the M×N mesh. The additional logic can comprise arbitration such that sequential requests are sent in different paths within the M×N mesh. Many other algorithms are possible. In embodiments, the LUT is programmable. The programming can be performed by a boot ROM, a boot code sequence, the operating system, system code, and so on. The programming can be based on estimated network traffic on one or more tiles or paths between tiles, or estimation. In some embodiments, the LUT is based on a physical layout of the plurality of tiles. When laid out on a chip, one or more elements can be rotated, flipped, etc. Thus, the LUT can be programmed to take the physical layout of each tile into account. The flow 100 includes sending, by the first tile, to the first intermediate tile, the communication packet 150. In embodiments, the sending includes the second routing. The sending can be based on the routing within one or more LUTs as described above.

In embodiments, the first routing and the second routing are based on a dynamic routing algorithm. A dynamic algorithm can be changed “on the fly” during operation of the mesh network. The dynamic routing algorithm can be updated after start-up such that the mesh can change routing algorithms on the fly. The dynamic routing algorithm can be based on a measurement of network traffic, one or more tiles or paths between tiles, or another measurement. In embodiments, the dynamic routing algorithm is based on one or more quality of service (QoS) agents. Data can be collected by one or more QoS agents within the mesh. The collection can occur during a timing window. A tile within the mesh can query a QoS agent for an optimized route to a target tile within the mesh. The one or more QoS agents can analyze network traffic within the mesh that was collected and communicate to determine the optimal routing path.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

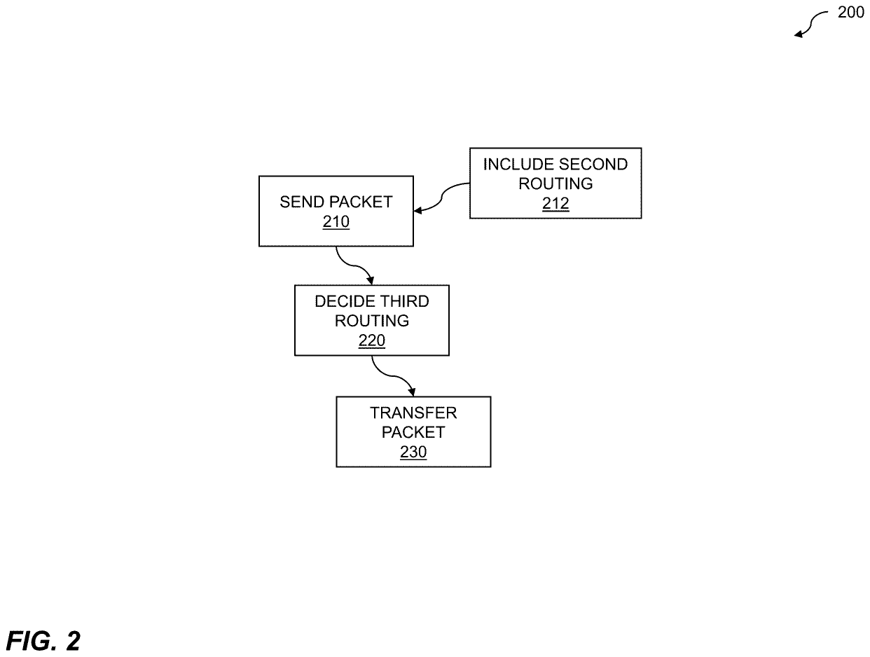

FIG. 2 is a flow diagram for transferring a packet. The flow 200 includes sending a packet 210. The packet can be sent using one or more protocols for on-chip communication in mesh networks. These protocols can include AMBA protocol, Wishbone protocol, TileLink, time-division multiplexing, MESI Protocol (Modified, Exclusive, Shared, Invalid), MOESI Protocol (Modified, Owned, Exclusive, Shared, Invalid), and/or other suitable protocols for routing and/or maintaining data coherency. In embodiments, each tile in the plurality of tiles is coherent. The sending can include a second routing 212. As described above, the second routing can be based on a second intermediate tile within the plurality of tiles. The second routing can be within the routing path from the first tile to the target tile. The second routing can be based on a LUT, an algorithm, and so on.

The flow 200 includes deciding, by the first intermediate tile, a third routing 220. In embodiments, the third routing is based on a third intermediate tile within the plurality of tiles. A first tile can be sent a packet which can include data and a first routing. The first routing can specify a first intermediate tile. The first tile can determine a second routing and send the data and the second routing to the first intermediate tile. The second routing can specify a second intermediate node. In like manner, the first intermediate tile can decide a third routing and transfer the data and the third routing to the second intermediate tile. In embodiments, the third routing is based on a third intermediate tile within the plurality of tiles. The third routing can specify a third intermediate tile. Embodiments include transferring, by the first intermediate tile, to the second intermediate tile, the communication packet 230, wherein the sending includes the third routing. While three intermediate tiles are described, in practice there can be more or fewer intermediate tiles in a communication path. This “N+1” process can be continued as needed for additional intermediate tiles until the data reaches the target tile.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

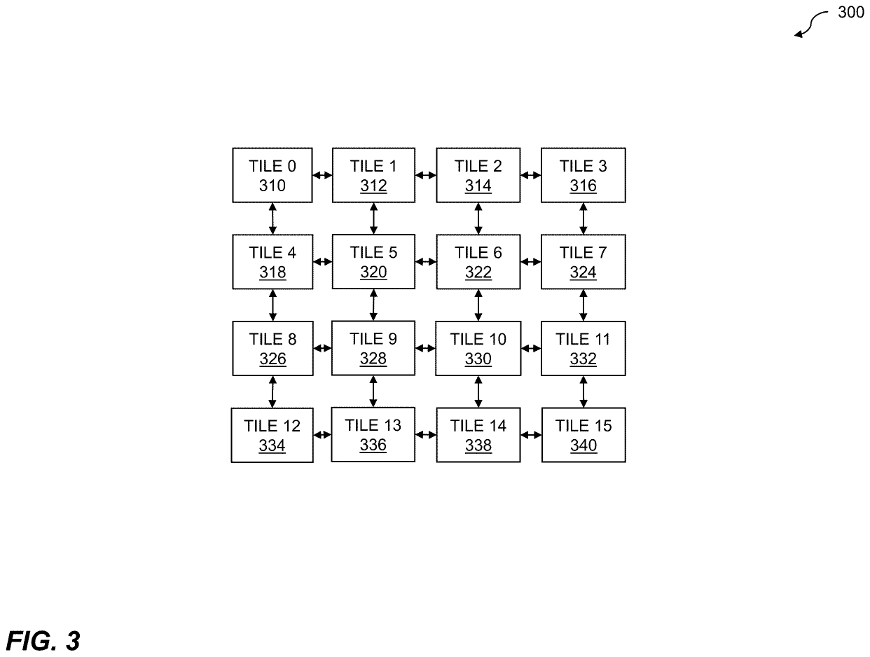

FIG. 3 is a block diagram of an M×N mesh. Mesh switching units can be configured in an M×N mesh topology. The block diagram 300 shows a 4×4 mesh. The tiles within the mesh can include tile 0 310, tile 1 312, tile 2 314, tile 3 316, tile 4 318, tile 5 320, tile 6 322, tile 7 324, tile 8 326, tile 9 328, tile 10 330, tile 11 332, tile 12 334, tile 13 336, tile 14 338, and tile 15 340. Each tile can include one or more of a memory controller interface (MCI), an input/output (I/O) mesh interface (IMI), and so on. Each tile can include a plurality of ports. The ports can include local ports, directional ports, and the like. The ports can be used for communication with other tiles within the mesh. Each tile can be in communication with nearest-neighbor tiles within the mesh. The nearest neighbor tiles within the mesh topology can be in one or more cardinal directions. The cardinal directions can include north, south, east, and west directions. Communication with a nearest neighbor tile (e.g., routing between neighbors) can be based on a cardinal direction priority. The cardinal direction priority can be east/west, then north/south. The direction priority can be static. Thus, the communication and/or routing can be based on a static routing algorithm. In embodiments, the static routing algorithm is vertical then horizontal. In other embodiments, the static routing algorithm is horizontal then vertical. In some embodiments, the static routing algorithm is based on each tile in the plurality of tiles. Noted above, the communication and/or routing between nearest-neighbor tiles can be accomplished using a network-on-chip (NOC). The network-on-chip can be based on techniques including router-based packet switching.

In the block diagram 300, the values of M and N are both equal to 4. However, in one or more embodiments, M and/or N can be larger, or smaller, than 4. In disclosed implementations, M may be unequal to N. The tiles can include mesh switching units (MSUs), where the MSUs can obtain and/or act on precalculated routing information in a coherent mesh network. The mesh topology is enabled by one or more communication protocols. In exemplary implementations, a network is accessed. The network can be implemented on a SoC, where the SoC includes a network-on-a-chip (NOC), and the NOC includes an M×N mesh topology, wherein the M×N mesh topology includes a coherent tile at each point of the M×N mesh topology. In embodiments, the network is within a system-on-chip (SoC). In embodiments, the network comprises a network-on-chip (NOC), wherein the NOC includes an M×N mesh topology, wherein the M×N mesh topology includes a tile at each point of the M×N mesh topology.

The communicating between tiles can be based on selecting an adjacent tile. A cardinal direction can be selected for sending a communication packet. In disclosed implementations, the cardinal direction can be indicated in a lookup table (LUT) for N+1 routing. For physical layout purposes, some implementations may rotate one or more switching units such that a “north” interface for rotated switching units may be oriented in the same direction as “east” for other switching units, as an example. In disclosed implementations, the physical layout variations can be accommodated by preloading routing information into the LUT for the corresponding tiles within a plurality of tiles in the mesh that account for the non-standard orientation. In embodiments, the LUT is based on a physical layout of the plurality of tiles.

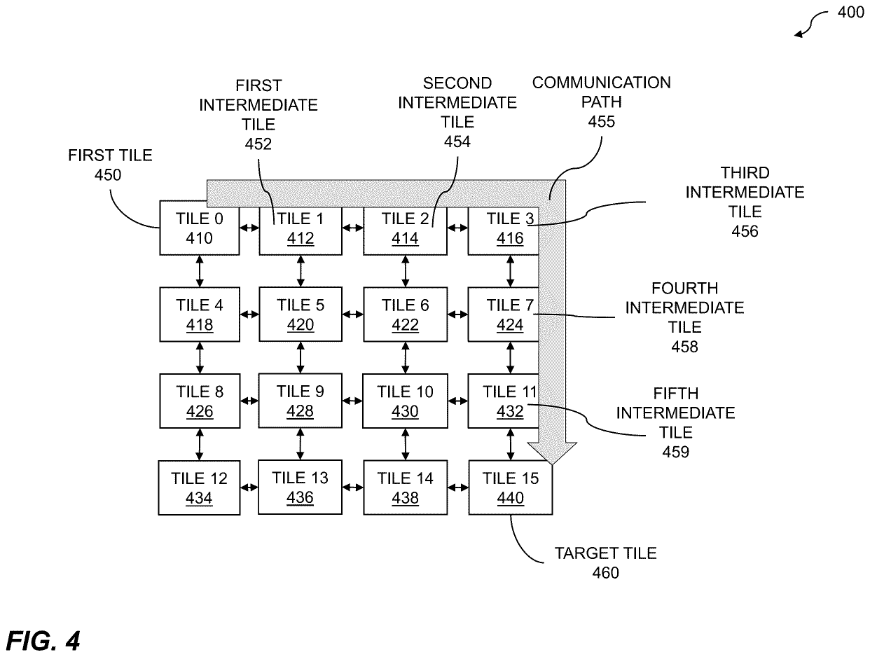

FIG. 4 is an illustration of routing. The illustration 400 shows an M×N mesh that may be similar to the mesh shown in FIG. 3. The tiles within the mesh can include tile 0 410, tile 1 412, tile 2 414, tile 3 416, tile 4 418, tile 5 420, tile 6 422, tile 7 424, tile 8 426, tile 9 428, tile 10 430, tile 11 432, tile 12 434, tile 13 436, tile 14 438, and tile 15 440. In the example shown, tile 0 410 is first tile 450, and tile 15 440 is the target tile 460. Thus, the first tile is sending a communication packet to the target tile. As the first tile and the target tile are non-adjacent, there is at least one intermediate tile that is used to transfer results along a communication path from the first tile to the target tile. In the illustration 400, multiple communication paths are possible. One of the possible communication paths is indicated at 455. Accordingly, given communication path 455, there are five intermediate tiles, indicated as tile 1 412, tile 2 414, tile 3 416, tile 7 424, and tile 11 432. Communication can be initiated by first tile 450. In the case of the first tile, the sending of a communication packet can include determining immediate routing information and intermediate tile routing information. For the communication path shown, the immediate routing information can include instructions for sending a communication packet from the first tile, tile 0 410, to the first intermediate tile 452, tile 1 412. The intermediate tile routing information can include instructions for sending the communication packet from the first intermediate tile 452 to the second intermediate tile 454. Thus, the routing information generated by first tile 450 can include both instructions for sending the communication packet from the first tile 450 to the first intermediate tile 452, as well as N+1 routing instructions that are also sent from the first tile 450 to the first intermediate tile 452. The N+1 routing instructions that are sent from the first tile 450 to the first intermediate tile 452 can be executed by the first intermediate tile 452 and can instruct the first intermediate tile 452 as to where the first intermediate tile 452 is to send the communication packet along its next hop along communication path 455.

The first intermediate tile 452 determines routing information that is provided to the second intermediate tile 454. The routing information that is provided to the second intermediate tile instructs the second intermediate tile as to the next hop along the communication path 455 to send the communication packet. In illustration 400, the instructions provided by the first intermediate tile are sent to the second intermediate tile 454 and can instruct the second intermediate tile to send the communication packet to the third intermediate tile 456 (tile 3 416). In general, for a communication path with intermediate tiles N, N+1, N+2, and so on, an intermediate tile N sends instructions to tile N+1 that specify to tile N+1 which tile is tile N+2. Thus, disclosed implementations provide precalculated routing information in a coherent mesh network, where the precalculated routing information provided by tile N to tile N+1 indicates to tile N+1 where the communication packet is to be routed immediately after tile N+1 (e.g., identifying tile N+2). This process repeats through the fourth intermediate tile 458, which sends the communication packet to the fifth intermediate tile 459 (tile 11 432). The fifth intermediate tile 459 is the last intermediate tile. The fifth intermediate tile 459 sends the communication packet to the target tile 460.

The routing can be statically determined a priori. In exemplary implementations, the routing information can be loaded into lookup tables, where each tile in the mesh has its own lookup table (LUT). The LUT can be hardcoded into a BIOS, bootloader, or other startup and/or operating system sequence. In embodiments, the LUT is programmable. In embodiments, the first routing and the second routing are based on a static routing algorithm. In some cases, the LUT can be programmed at the start of loading a given program or process, enabling different communication paths on an application basis. As can be seen in illustration 400, the communication path 455 starts horizontally from first tile 450 until the third intermediate tile 456 and then proceeds vertically until the target tile 460. In embodiments, the static routing algorithm is horizontal then vertical. Other communication paths are possible. For example, another possible communication path between first tile 450 and target tile 460 can include starting from first tile 450 vertically to tile 12 434, and then horizontally from tile 12 434 to target tile 460. In some embodiments, the static routing algorithm is vertical then horizontal. In general, each intermediate tile (except the last intermediate tile) determines where the next intermediate tile sends the communication packet. The last intermediate tile sends the communication packet to the target tile. Thus, in embodiments, the static routing algorithm is based on each tile in the plurality of tiles.

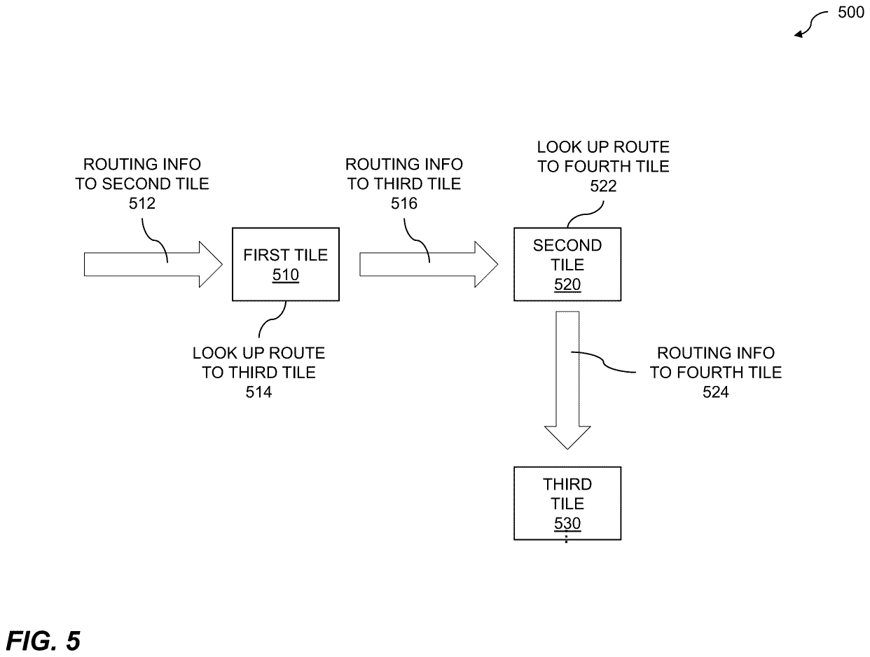

FIG. 5 is an illustration of looking up routing information. The illustration 500 shows the general sequence of operations for intermediate tiles in a communication path. The tiles shown in illustration 500 can be intermediate tiles. Routing information to the second tile 512 is provided (e.g., from another tile, not shown) to first tile 510. The first tile 510 can access a LUT within the first tile in order to look up a route from the second tile to the third tile 514. In embodiments, each tile within the plurality of tiles includes a lookup table (LUT), wherein the LUT includes one or more routes from each tile to the target tile. Recall that a first tile can determine a second routing. The information accessed from a LUT within the first tile 510 can include instructions on how the second tile 520 can send information to the third tile 530. Thus, the information accessed from the LUT within the first tile can include routing information to the third tile 516. In embodiments, the determining includes finding the second routing in the LUT.

The routing information to the third tile 516 is sent to the second tile 520. The information accessed from the LUT within the second tile 520 can include instructions on how the third tile 530 can send information to a fourth tile (not shown). Similar to as described for the first tile 510, the second tile 520 can access a LUT within the second tile in order to look up a route from the third tile to a fourth tile 522. Thus, the information accessed from the LUT within the second tile can include routing information to the fourth tile 524. The routing information to the fourth tile 524 is sent to the third tile 530. Accordingly, in general, tile N sends routing information to tile N+1 that identifies tile N+2. Thus, as an example, first tile 510 can be tile N, second tile 520 can be tile N+1, and the routing information to the third tile 516 identifies the third tile 530, which can be tile N+2. There can be any number of intermediate tiles, such as tiles 520 and 530, in the communication path between the first tile and the target tile (not shown in illustration 500). In embodiments, the second intermediate tile comprises the target file.

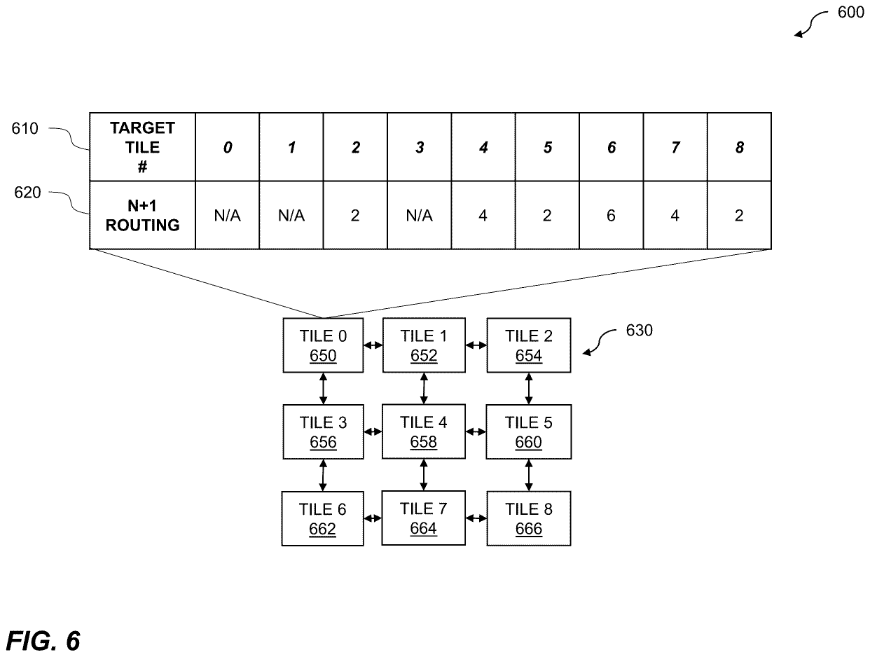

FIG. 6 is an example lookup table. In exemplary implementations, each tile can include a lookup table (LUT). Each lookup table may have unique contents among the tiles within a mesh network. The example lookup table 600 includes a first row 610 specifying a target tile. The example lookup table 600 includes a second row 620 indicating a corresponding N+1 routing for the next tile. That is, the N+1 routing entry specifies where the next tile is to send the communication packet. An M×N mesh 630 that includes multiple tiles arranged as a 3×3 mesh is shown. The lookup table shown is contained within tile 0 650. The information in row 620 can indicate a don't care (DC) condition if routing does not apply. As an example, for a target tile of 1, or a target tile of 3, a DC condition applies, as indicated by the “N/A” (Not Applicable) in those entries in row 620. Since tile 1 652 and tile 3 656 are both adjacent to tile 0 650, there are no intermediate tiles, and thus, there is no N+1 routing to be specified. A similar case applies for tile 0, for which an “N/A” is also indicated in row 620.

For a target tile of tile 2 654, row 620 of the lookup table contains a value of 2 for the N+1 routing. The N+1 routing value is provided to tile 1 652, which in turn routes the communication packet to tile 2 654, which is the target tile. For a target tile of tile 5 660, row 620 of the lookup table contains a value of 2 for the N+1 routing. The N+1 routing value is provided to tile 1 652, which in turn routes the communication packet to tile 2 654, which is an intermediate tile on the communication path to target tile 5 660. For a target tile of tile 8 666, row 620 of the lookup table contains a value of 2 for the N+1 routing. The N+1 routing value is provided to tile 1 652, which in turn routes the communication packet to tile 2 654, which is an intermediate tile on the communication path to target tile 8 666. For a target tile of tile 4 658, row 620 of the lookup table contains a value of 4 for the N+1 routing. The N+1 routing value could be provided to either tile 1 652 or tile 3 656, which in turn routes the communication packet to tile 4 658, which is the target tile. The decision on which route to use can be based on a static routing algorithm. In embodiments, the static routing algorithm is vertical then horizontal. In other embodiments, the static routing algorithm is horizontal then vertical. In some embodiments, the static routing algorithm is based on each tile in the plurality of tiles. That is, the static algorithm can be customized based on the tile sending the communication packet. For a target tile of tile 7 664, row 620 of the lookup table contains a value of 4 for the N+1 routing. The N+1 routing value could be provided to either tile 1 652 or tile 3 656, which in turn routes the communication packet to tile 4 658, which is an intermediate tile on the communication path to the target tile 7 664. For a target tile of tile 6 662, row 620 of the lookup table contains a value of 6 for the N+1 routing. The N+1 routing value is provided to tile 3 656, which in turn routes the communication packet to tile 6 662, which is the target tile.

In embodiments, the first routing and the second routing are based on a dynamic routing algorithm. The routing as described above can be dynamic, enabling communication paths to change during program execution. The communication paths can change based on a variety of conditions, such as network congestion. If a given communication path is saturated with traffic, a LUT within one or more of the tiles may be updated to implement a new path. The updating can be accomplished by one or more quality of service agents, which can monitor traffic and re-route communications. In embodiments, the dynamic routing is based on one or more quality of service (QoS) agents. In some implementations, the QoS agents can communicate directly with each tile in the mesh, thus eliminating the need for a LUT at each node.

As an example, for a first (initial) tile of tile 0 650 and a target tile of tile 5 660, a first possible communication path can include intermediate tiles 1 652 and 2 654, whereas a second possible communication path can include intermediate tiles 3 656 and 4 658. Initially, the first communication path can be programmed into the corresponding LUTs of the tiles. However, in the case of increased network congestion along the first communication path, the tiles can update the LUT to use the second communication path. The updating can be based on one or more QoS agents which can monitor network traffic on one or more network nodes within the mesh. In embodiments, each tile within the plurality of tiles includes a lookup table (LUT), wherein the LUT includes one or more routes from each tile to the target tile. In embodiments, the LUT is programmable. The programming can be based on one or more QoS agents. In some implementations, the LUTs can contain multiple rows of N+1 routings. When conditions warrant changing the routing, the tile can retrieve routing information from a different row of N+1 routings. In this way, the dynamic routing can serve to mitigate the adverse effects of network congestion.

A benefit of the disclosed implementations includes improved timing within each tile. A mesh switching unit within each tile can be responsible for determining where to send a communication packet that was received and is scheduled to be delivered to a target tile within the mesh. When the tile must calculate the next hop in series with other functions, timing can be difficult to meet. Separating the routing calculation and generating future N+1 routes can further improve timing, taking the routing calculation out of timing critical paths. An additional benefit of disclosed implementations includes fault tolerance. As an example, for a first (initial) tile of tile 0 650 and a target tile of tile 5 660, a first possible communication path and second possible communication path can exist as previously stated. Initially, the first communication path can be programmed into the corresponding LUTs of the tiles. However, in the case of a tile failure along the first communication path (e.g., a failure of tile 1 652), the remaining functioning tiles within the mesh can update the LUT to use the second communication path. In this way, the dynamic routing can serve to mitigate the adverse effects of component failure, providing improved fault tolerance and robustness for the system.

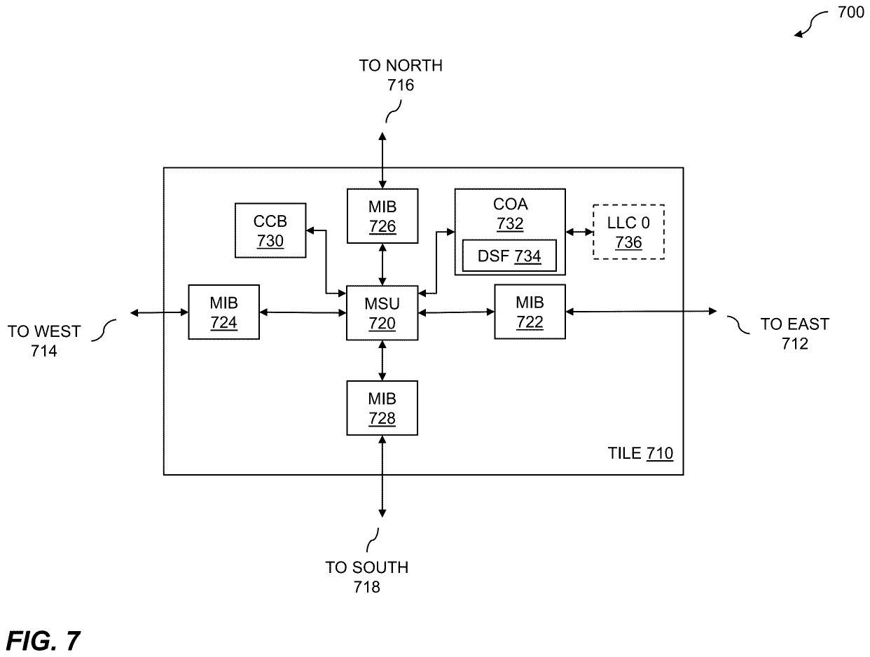

FIG. 7 is a block diagram of a tile. In disclosed implementations, a plurality of tiles can be configured in an M×N mesh topology. The tiles can include one or more of a memory controller interface, an I/O mesh interface, and so on. A tile can further include elements for managing coherency across the M×N mesh. The various elements of a tile support precalculated routing information in a coherent mesh network. A system-on-chip (SoC) is accessed, wherein the SoC includes a network-on-a-chip (NOC), wherein the NOC includes an M×N mesh topology, wherein the M×N mesh topology includes a coherent tile at each point of the M×N mesh topology. Disclosed implementations can obtain precalculated routing information and send that information to intermediate tiles within a communication path to facilitate efficient and robust inter-tile communication.

A mesh topology can include M×N elements in a mesh, grid, fabric, or any other suitable topology. The M×N elements, which can be referred to generically as tiles associated with the network topology, can include elements based on a variety of configurations that perform a variety of operations, and so on. The tiles can communicate with their nearest neighbor tiles that are located in cardinal directions from each tile. A given tile can be configured to perform one or more operations. Each tile can include one or more elements. A tile can be configured as a coherent mesh unit (CMU), a memory controller interface (MCI), an I/O control interface (ICI), and so on. The tile can be configured to enable coherency management. In the block diagram 700, the tile 710 can communicate with nearest neighbor tiles that are located in cardinal directions from tile 710. The nearest neighbor communications can include cardinal directions to the east 712, to the west 714, to the north 716, and to the south 718. In disclosed implementations, the use of cardinal directions can be prioritized. In disclosed implementations, the cardinal direction priority can be east/west, then north/south.

The tile 710 can include a mesh switching unit (MSU) 720. The MSU may also be referred to as a mesh interface unit (MIU). The MSU can communicate with other MSUs associated with further switching units using one or more interfaces. Recall that a tile can determine a routing to an N+1 tile within a route to a target file. The MSU can include logic for routing functions such as described above. In embodiments, the determining is accomplished by a mesh switching unit (MSU). The tile 710 can include one or more mesh interface blocks (MIBs). The MIBs can enable communication between tile 710 and other tiles within the mesh. The other tiles can be located in cardinal directions from tile 710. The tile shown can include four MIBs such as MIB 722, MIB 724, MIB 726, and MIB 728. MIB 722 enables communication to the east, MIB 724 enables communication to the west, MIB 726 enables communication to the north, and MIB 728 enables communication to the south.

In some implementations, due to physical layout of devices, one or more tiles can be a different orientation from each other. For example, some tiles may be oriented so that “north” of the tile aligns with a general “north” direction of the mesh, whereas others may be rotated 90 or 270 degrees, such that “west” of the tile aligns with a general “north” direction of the mesh or that “east” of the tile aligns with a general “north” direction of the mesh. In disclosed implementations, these orientation changes can be accommodated in the LUT by indicating a particular MIB to use for a given routing. In embodiments, the LUT is based on a physical layout of the plurality of tiles.

In disclosed implementations, the tile 710 comprises a coherent tile. The coherent tile can accomplish coherency within a block such as a cache coherency block. The cache coherency block can include elements such as processor cores, local cache memory, shared cache memory, intermediate memories, and so on. In embodiments, the first coherent tile includes a cache coherency block (CCB) such as CCB 730 and a coherency ordering agent (COA) such as a COA 732. The CCB can include a “block” of storage, where the block can include one or more of shared local cache, shared intermediate cache, and so on. The CCB can maintain coherency among cores such as processor cores, tiles, switching units, etc. The COA can be used to control coherency with other elements outside of the M×N mesh. The CCB and the COA can be included in one or more coherent tiles of switching units within the M×N mesh. In disclosed implementations, the adjacent coherent tile can include a CCB and a COA. The adjacent block CCB and COA can be used to maintain memory coherency within the adjacent coherent tile. In disclosed implementations, the adjacent coherent tile can include one or more memory control interfaces (MCIs). In embodiments, at least one tile in the plurality of tiles includes a cache coherency block (CCB).

The COA can be used to order cache accesses based on an address to be accessed. The address can include a target address associated with a memory load operation or a memory store operation. The COA can include a directory-based snoop filter (DSF) such as DSF 734. The DSF can be used to determine the current owner of a block of memory within the system. The DSF 734 can also determine the sharers of a block of memory within the system. The DSF can store information pertaining to a specific address range. The block of memory can include a cache line, a block of cache lines, and so on. In disclosed implementations, the DSF can include an M-way associative set of tables that includes an index number, a valid bit, a presence vector, an owner ID field, an owner valid field, and so on. The COA can be used to determine which cache to access. The cache can include a last level cache such as last level cache (LLC) 0 736. In disclosed implementations, only some of the COAs within an M×N matrix include an LLC. The LLC can be accessible by two or more of the switching units within the M×N mesh, a plurality of M×N meshes, and so on. The LLC can include a cache between the M×N mesh and a shared memory such as a shared system memory.

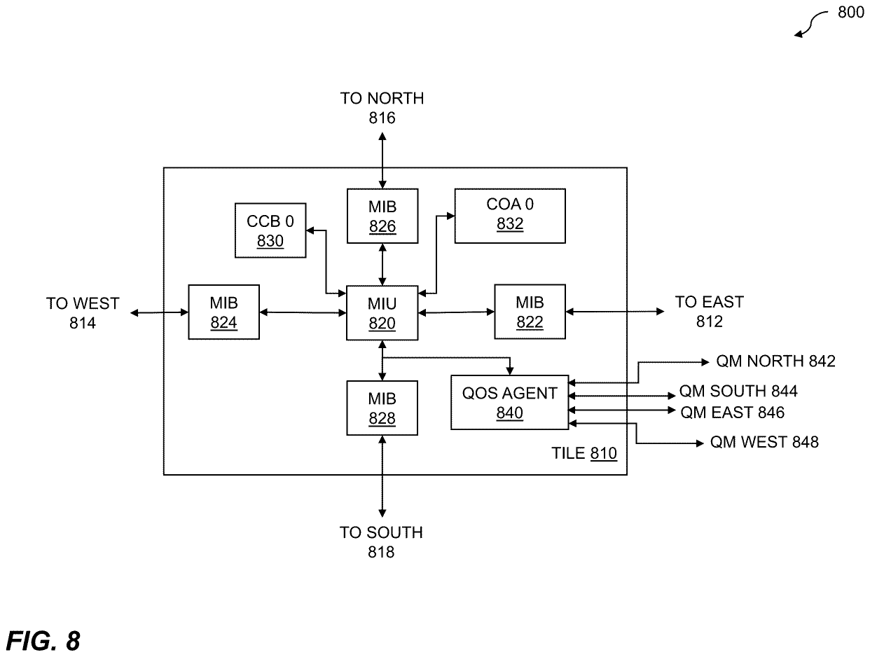

FIG. 8 is a block diagram of a tile with a quality-of-service (QoS) agent. Discussed previously and throughout, a plurality of tiles can be configured in an M×N topology such as an M×N mesh topology. The tiles can include one or more of a memory controller interface, an I/O mesh interface, and so on. A tile can further include elements for managing communication across the M×N topology. The various elements of a tile support adaptive SoC routing with distributed quality-of-service agents. A system-on-chip (SoC) can be accessed. The SoC can include a mesh network. The mesh network can include a plurality of tiles, where at least one tile within the plurality of tiles includes a quality-of-service (QoS) agent. Network traffic data can be collected by a first QoS agent within a first tile within the plurality of tiles. The network traffic data can be associated with the first tile. The network traffic data can occur during a first timing window. The first QoS agent can receive a request by a primary device within the first tile to send data to a secondary device in a second tile within the plurality of tiles. The first QoS agent can analyze the network traffic data. A first routing agent within the first tile can select an intermediate tile within the plurality of tiles. The selecting can be based on the analyzing. The primary device can send the data to the intermediate tile.

A network in a mesh topology that comprises M×N elements is described above. The M×N elements, which can be referred to generically as tiles or nodes associated with the mesh topology, can include various elements. The included elements can be based on a variety of tile configurations that can perform a variety of operations. The tiles can communicate with their nearest neighbor tiles within the network. The nearest neighbor tiles can be located in a diagonal direction from each tile (e.g., northeast, southeast, southwest, and northwest), in cardinal directions from each tile (e.g., north, south, east, and west), and so on. A given tile can be configured to perform one or more operations. Each tile can include one or more elements. A tile can be configured as a coherent mesh unit (CMU), a memory controller interface (MCI), an input/output (I/O) mesh interface (IMI), and so on. The block diagram 800 shows a tile 810. The tile can be configured to enable coherency management. In disclosed implementations, the tile is configured to enable adaptive SoC routing with distributed quality-of-service agents. The tile 810 can communicate with nearest neighbor tiles that are located in diagonal, cardinal, etc. directions from tile 810. A nearest neighbor tile can include an intermediate node, where the intermediate node can assist sending data between a first node and a second node within the mesh network. The nearest neighbor communications can include diagonal directions and cardinal directions to the east 812, to the west 814, to the north 816, and to the south 818. For some routing situations, the cardinal directions can be prioritized. In a usage example, the cardinal direction priority can be east/west, then north/south.

The switching unit can include a mesh interface unit (MIU) 820. In disclosed implementations, the MIU can initiate adaptive SoC routing. The routing can be accomplished with distributed quality-of-service agents. The SoC routing operation can be associated with a data sending operation. The data sending operation can include a memory access operation such as a read (load), write (store), read-modify-write, and so on. The MIU can generate a request by a primary device within a first node to send data to a secondary device in a second node within the plurality of nodes. The secondary device can be accessible by the first device via one or more intermediate nodes within the plurality of nodes. The MIU can communicate with other MIUs associated with further switching units using one or more interfaces. The MIU can include a routing agent. The routing agent can include a route including an intermediate node, where the intermediate node is located along a route or path between the first node and the second node. The routing agent can implement an X, Y (horizontal then vertical) algorithm, a Y, X (vertical then horizontal) algorithm, and so on. The routing agent can be used to pick a further intermediate node. The picking of the further intermediate node can be altered by the QoS agent. The picking of the further intermediate node can be based on examining network traffic data.

The tile can include one or more mesh interface blocks (MIBs). The MIBs can enable communication between the tile and other tiles within the mesh. The other tiles can be located in cardinal directions from tile 810. The tile shown can include four MIBs such as MIB 822, MIB 824, MIB 826, and MIB 828. MIB 822 enables communication to the east, MIB 824 enables communication to the west, MIB 826 enables communication to the north, and MIB 828 enables communication to the south. The other tiles can also be located in diagonal directions from tile 810. The tile can comprise a node within a plurality of nodes (tiles) within a system-on-chip (SoC). The node (tile) can enable adaptive SoC routing within the M×N mesh. The node can further include a cache coherency block (CCB). The cache coherency block can include processors such as processor cores, local cache memory, shared cache memory, intermediate memories, and so on. In disclosed implementations, the node includes a cache coherency block (CCB) such as CCB 0 830 and a coherency ordering agent (COA) such as a COA 0 832. The CCB can include a “block” of storage, where the block can include one or more of shared local cache, shared intermediate cache, and so on. The CCB can maintain coherency among cores such as processor cores, tiles, switching units, etc. The COA can be used to control coherency with other elements outside of the M×N mesh. The CCB and the COA can be included in one or more switching units within the M×N mesh. In disclosed implementations, the adjacent coherent node can include a CCB and a COA. The adjacent block CCB and COA can be used to maintain memory coherency within the adjacent coherent tile. In disclosed implementations, the adjacent coherent tile can include one or more memory control interfaces (MCIs). The COA or routing agent can be used to route data between the first node that is sending the data and the second node that is receiving the data.

The switching unit can include a quality-of-service (QoS) agent 840. In disclosed implementations, at least one node within the plurality of nodes can include a QoS agent. A node can include more than one QoS agent. The QoS agent can perform a plurality of tasks within a switching unit. In disclosed implementations, a first QoS agent can collect network traffic data. The network traffic data can be collected during a first timing window. The network traffic that is collected can be associated with the first node. In disclosed implementations, the first QoS agent can receive a request by a primary device within the first node. The request can include a data request such as a request to send data. In disclosed implementations, the request can comprise sending data to a secondary device in a second node within the plurality of nodes. The data can include raw data, partially processed data, processed data, and so on. The data can be sent to the second node for further processing. The first QoS agent can analyze the network traffic data. The analysis can include examining network utilization, data such as packet data send success rates, send failure rates, send retry rates, and the like. A first routing agent within the first node can select an intermediate node within the plurality of nodes, where the selecting is based on the analyzing. Recall that sending data between nodes that are adjacent can be a degenerate case, where the two nodes communicate directly. In other cases where data is sent from a first node to a second node, the nodes are non-adjacent. As a result, one or more intermediate nodes can be picked in order to form a route or path from the first node to the second node. Thus, a routing agent within the node can select an intermediate node based on the analyzing. In disclosed implementations, the routing agent within the node can select an intermediate node by setting a particular row of N+1 routings in a LUT as an active routing scheme.

The QoS agent within the tile can be in communication with one or more additional QoS agents. The additional QoS agents can include QoS agents within other tiles. The communication between QoS agents can include sharing latency information. A first QoS agent within a first tile and a second QoS agent within a second tile can communicate over a separate packetized mesh interface. The communication between QoS agents can occur in the cardinal directions discussed previously. In the tile 810, the QoS agent-to-agent communication can occur through one or more QoS mesh interfaces (QMs) such as QM north 842, QM south 844, QM east 846, and QM west 848. The latency information can be used for controlling the sending of data from the first node to the second node. In disclosed implementations, the sending can be based on an estimated latency. The estimated latency can be associated with the sending of data between nodes based on the collected network traffic data. As the QoS agents within intermediate nodes pick further intermediate nodes to determine a route or path between the first node and the second node, an accumulated latency can be determined. The sending can include an accumulated latency associated with the request. The estimated latency and the accumulated latency can be used to determine whether a proposed route between the first node and the second node is viable. In a first usage example, the accumulated latency can be too long which would cause data to arrive too late to prevent stalling of the M×N mesh. In a second usage example, the accumulated latency can be used to determine that too many intermediate nodes are associated with a possible route. Thus, an alternative route that utilizes fewer intermediate nodes can be sought. In embodiments, the dynamic routing algorithm is based on one or more quality of service (QoS) agents.

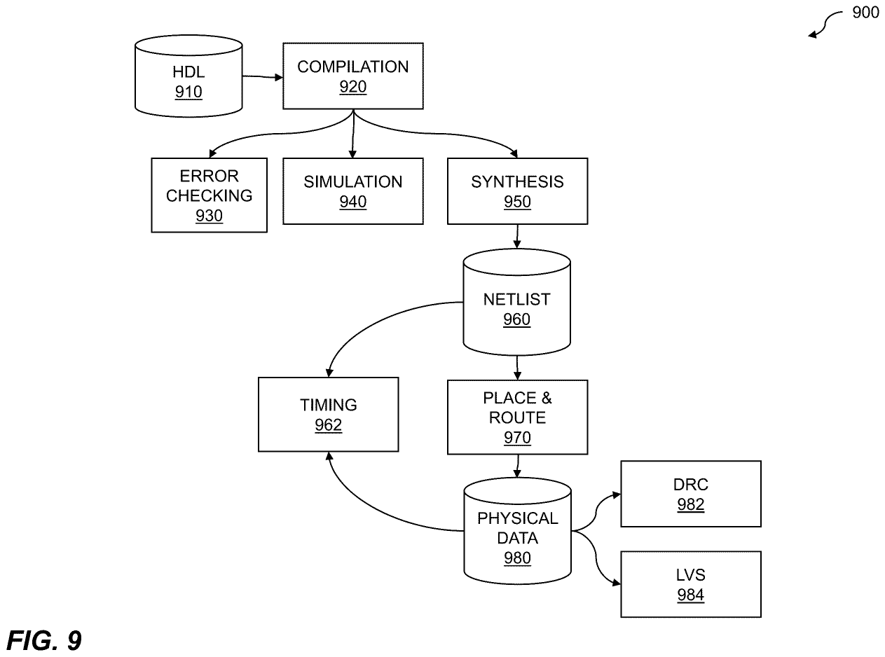

FIG. 9 is a design flow for semiconductor logic generation. Semiconductor logic generation can enable precalculated routing information in a coherent mesh network to be implemented. The design flow can be based on one or more design automation tools and can include instructions and/or functions for design, generation of semiconductor logic for, and implementation of integrated circuits that support non-flushing vector micro-operations with VSET. The design flow 900 can include instructions and/or functions for generation and/or manipulation of design data such as hardware description language (HDL) constructs for specifying structure and operation of an integrated circuit. The design flow 900 can further perform operations to generate and manipulate Register Level Transfer (RTL) abstractions. These abstractions can include parameterized inputs that enable specifying elements of a design such as a number of elements, sizes of various bit fields, sizes of caches, number of registers, enablement of certain features (such as architectural extensions), and so on. The parameterized inputs can be used as inputs to a logic synthesis process which can create semiconductor logic that implements the gate-level abstraction of the HDL. The gate level data can be further processed and used for fabrication of integrated circuit (IC) devices.

Modern integrated circuit designs are typically created using complex software design automation tools. The design flow 900 includes a hardware description language (HDL) 910 of a logic design. The HDL can enable a human to create and test a description of a logic function, logic block, system, etc. they want to design by describing the system using code. Any HDL can be used including Verilog®, VHDL, SystemC, Chisel, and other languages. The code can describe the system at various levels of abstraction. The levels of abstraction can include a high level of abstraction that describes the behavior of the system, at a register transfer level (RTL), which describes the design based on the transfer of data between registers, at a gate level description, which names the particular circuits used and the interconnections between them, and so on. For example, a high level behavioral description may describe multiplication as C=A*B. An RTL level may describe loading data into register A, loading data into register B, performing a multiplication operation, and storing the product of A and B in register C. A circuit level description may name the particular circuits to use and the interconnections among them. At the RTL stage, disclosed implementations can capture both functional behavior and timing relationships. While the behavioral description can be the most user friendly, the RTL description can enable more control over how the design is implemented. Common text file formats, such as “.v”, “.vhd”, are typically used for the HDL source code in the semiconductor design flow.

The HDL source code can be compiled 920. The compilation can comprise one or more analysis, parsing, and/or elaboration steps. The compilation can result in an executable model of the HDL source code, which can be suitable for further steps of design automation. The executable model can be hierarchical. The compilation process can include error checking 930. The error checking can include syntactical checking; semantic checking; checking of references to other referenced libraries, designs, and models; etc. One or more implementations may include automated linting tools that detect undeclared signals, mismatched bit widths, or unused variables in HDL code.

One or more implementations may include simulation 940 of the HDL or RTL code prior to synthesis. Simulation environments can enable verification of design parameters such as functional correctness, timing behavior, and corner cases. By running testbenches against the HDL code, designers can confirm that arbitration logic operates as intended before committing to gate level synthesis. Simulation can also provide visibility into signal waveforms and processor request interactions, ensuring that arbitration criteria are correctly enforced. One or more implementations may also address conflicts that arise in visualization and reporting. For example, waveform viewers and schematic generators may use color coding to distinguish signals, buses, and states. Conflicts in color assignments or overlapping graphical elements can obscure analysis. Tools therefore include configurable color palettes and conflict resolution mechanisms to ensure clarity in simulation results and design documentation.

Synthesis 950 tools can be used to map the abstract operations captured by the HDL code into logic gates, flip-flops, cache structures, interconnect structures, etc. This process can enable automated generation of semiconductor logic that can be implemented in silicon, while preserving the intended arbitration and control functions originally specified. The synthesis can produce a gate level netlist 960 that represents the actual semiconductor logic structures such as described above. The netlist can be a technology-mapped netlist (e.g., mapped to a specific semiconductor fabrication technology). Synthesized netlists may be represented in formats such as EDIF, Liberty, and so on. In some implementations, checking can be performed to ensure that the logic generated by the synthesis tool is equivalent to the logic defined by the HDL source code. This can be accomplished by one or more testbenches, running one or more tests on larger blocks of logic and comparing those to the synthesized circuits, performing formal verification to prove logical equivalence between HDL and the netlist, and so on. Timing 962 can be performed on the netlist. The timing can generate an initial view including critical paths and/or paths that should be retimed with different synthesis directions. The timing information can be generated from established models of semiconductor devices, gates, etc. that have been selected by the synthesis tool. Estimates for wiring delays can also be included in the timing data.

The gate level netlist can be placed and routed 970 to produce physical data 980 which represents layout suitable for fabrication. Examples of place and route tools are Cadence® Innovus®, Synopsis IC complier®, versatile place and route (VPR), nextpnr, and others. Layout data is often exchanged in GDSII or OASIS formats. These standardized formats enable interoperability across tools and vendors, and support error checking during import/export. Timing 962 can again be run on the placed and routed design to ensure that the design meets cycle time requirements, taking into account more accurate wire lengths, parasitics, clock domains, and so on. Design rule checks (DRC) 982 and layout versus schematic (LVS) 984 checks can confirm that the generated semiconductor logic adheres to fabrication constraints and matches the intended design. This tool-based flow demonstrates how software code can be transformed into concrete semiconductor logic structures, providing enabling support for claims directed to logic generation.

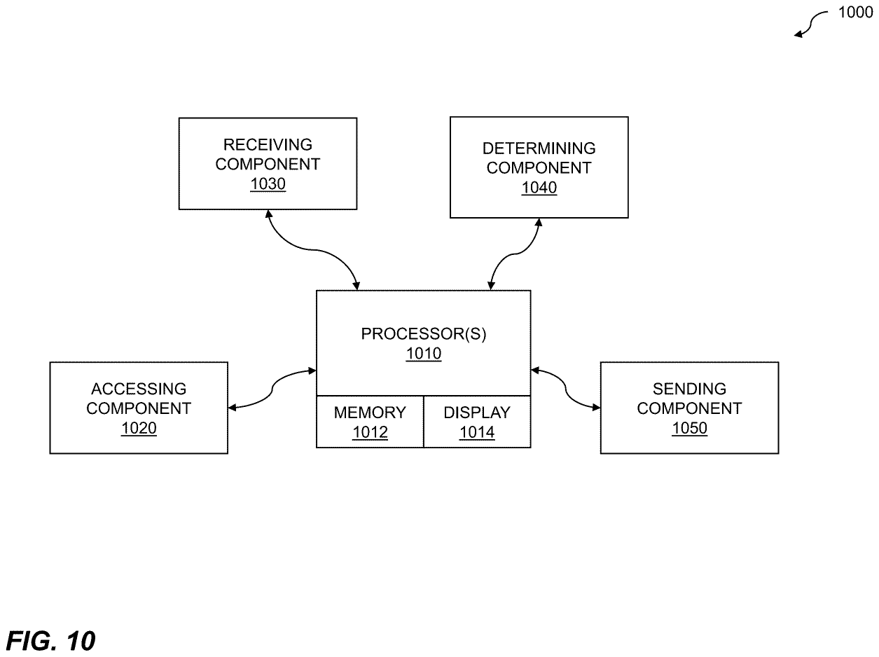

FIG. 10 is a system diagram for precalculated routing information in a coherent mesh network. The system 1000 can comprise a computer system for implementation of precalculated routing information in a coherent mesh network. The computer system can be based on semiconductor logic. The system can include one or more of processors, memories, cache memories, queues, displays, communications channels and networks, and so on. The system 1000 can include one or more processors 1010. The processors can include standalone processors within integrated circuits or chips, processor cores in FPGAs or ASICs, two or more processor cores within a multiprocessor, and the like. The one or more processors 1010 are coupled to a memory 1012 which stores instructions, operations, network traffic data, data requests, estimated latencies, accumulated latencies, routing information, and so on. The memory can include one or more of local memory, shared cache memory, shared hierarchical cache memory, system memory such as shared system memory, etc. The system 1000 can further include a display 1014 coupled to the one or more processors. The display can be used for displaying data, instructions, operations, memory queue contents, various types of latencies, routing information, etc. The operations can route operations, data transfer operations, and so on.

The system 1000 can include an accessing component 1020. The accessing component 1020 can include functions and instructions for accessing a network, wherein the network comprises a plurality of tiles, wherein each tile in the plurality of tiles includes a mesh switching unit. The network can be implemented on a circuit board, within a chip, such as a SoC, or other suitable network implementation. The network can be implemented as a NOC. The network can comprise a plurality of tiles. The network can be in the form of a grid, mesh, ring, torus, or any other network topology. Each tile in the plurality of tiles can include a mesh switching unit.

The system 1000 can include a receiving component 1030. The receiving component 1030 can include functions and instructions for receiving, by a first tile within the plurality of tiles, a communication packet, wherein the communication packet specifies a target tile within the network, wherein the first tile and the target tile are not adjacent within the network, and wherein the communication packet includes a first routing, wherein the first routing includes a first intermediate tile within the plurality of tiles. The communication packet can include one or more routing parameters, including a target tile within the network. The routing information can further include other information, such as intermediate tiles, a packet priority, and/or other routing information.

The system 1000 can include a determining component 1040. The determining component can include functions and instructions for determining, by the first tile, a second routing, wherein the second routing is based on a second intermediate tile within the plurality of tiles. The determining can be based on information within lookup tables. In disclosed implementations, the lookup tables can include a row of N+1 routings for each target tile. In disclosed implementations, the lookup tables can include multiple rows of N+1 routings, where at any point during operation of the processor, one row of N+1 routings is set as an active routing scheme. Based on network congestion, and/or fault tolerance conditions, another row in the LUT may be set as the active routing scheme, in order to route communication packets away from congestion and/or faulty tiles.

The system 1000 can include a sending component 1050. The sending component can include functions and instructions for sending, by the first tile, to the first intermediate tile, the communication packet, wherein the sending includes the second routing. Thus, for a given tile N, the tile N sends to tile N+1, routing information that tile N+1 uses to route the communication from tile N+1 to tile N+2. In this way, disclosed implementations provide a mesh processor system in which multiple tiles are arranged in a grid-based architecture and enable efficient communication between tiles for high performance and scalability. Disclosed implementations can improve data transfer by enabling distributed N+1 next-hop computation, in which each intermediate tile in a communication path only computes the tile that the next tile is to send the packet to. This approach can provide several key advantages. First, the disclosed implementations can reduce per-tile computational complexity, ensuring that tiles can forward packets in a fixed number of clock cycles. Moreover, the lightweight routing logic provided by disclosed implementations enables tiles to spend more clock cycles and other resources on computation, rather than spending cycles on complex route determination schemes. Furthermore, by limiting per-tile decision-making to a fixed number of cycles, disclosed implementations provide a mesh system in which latency becomes predictable and bounded. With the N+1 next-hop computations among intermediate nodes in a mesh processor system as provided by disclosed implementations, system performance can be significantly improved through lower computational overhead, increased parallelism, predictable latency, and enhanced scalability. Thus, disclosed embodiments can improve inter-tile communication, enabling modern AI, cloud computing, and other complex systems to efficiently manage massive parallel workloads while ensuring high-speed, low-latency data movement.

The system 1000 can include a computer program product embodied in a non-transitory computer readable medium for instruction execution, the computer program product comprising code which causes one or more processors to generate semiconductor logic for: accessing a network, wherein the network comprises a plurality of tiles, wherein each tile in the plurality of tiles includes a mesh switching unit; receiving, by a first tile within the plurality of tiles, a communication packet, wherein the communication packet specifies a target tile within the network, wherein the first tile and the target tile are not adjacent within the network, and wherein the communication packet includes a first routing, wherein the first routing includes a first intermediate tile within the plurality of tiles; determining, by the first tile, a second routing, wherein the second routing is based on a second intermediate tile within the plurality of tiles; and sending, by the first tile, to the first intermediate tile, the communication packet, wherein the sending includes the second routing.

The system 1000 can include a computer system for instruction execution comprising: a memory which stores instructions; one or more processors attached to the memory wherein the one or more processors, when executing the instructions which are stored, are configured to: access a network, wherein the network comprises a plurality of tiles, wherein each tile in the plurality of tiles includes a mesh switching unit; receive, by a first tile within the plurality of tiles, a communication packet, wherein the communication packet specifies a target tile within the network, wherein the first tile and the target tile are not adjacent within the network, and wherein the communication packet includes a first routing, wherein the first routing includes a first intermediate tile within the plurality of tiles; determine, by the first tile, a second routing, wherein the second routing is based on a second intermediate tile within the plurality of tiles; and send, by the first tile, to the first intermediate tile, the communication packet, wherein the sending includes the second routine.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for sharing data comprising:
accessing a network, wherein the network comprises a plurality of tiles, wherein each tile in the plurality of tiles includes a mesh switching unit;
receiving, by a first tile within the plurality of tiles, a communication packet, wherein the communication packet specifies a target tile within the network, wherein the first tile and the target tile are not adjacent within the network, and wherein the communication packet includes a first routing, wherein the first routing includes a first intermediate tile within the plurality of tiles;
determining, by the first tile, a second routing, wherein the second routing is based on a second intermediate tile within the plurality of tiles; and
sending, by the first tile, to the first intermediate tile, the communication packet, wherein the sending includes the second routing.

2. The method of claim 1 wherein the first routing and the second routing are based on a static routing algorithm.

3. The method of claim 2 wherein the static routing algorithm is vertical then horizontal.

4. The method of claim 2 wherein the static routing algorithm is horizontal then vertical.

5. The method of claim 2 wherein the static routing algorithm is based on each tile in the plurality of tiles.

6. The method of claim 2 wherein each tile within the plurality of tiles includes a lookup table (LUT), wherein the LUT includes one or more routes from each tile to the target tile.

7. The method of claim 6 wherein the determining includes finding the second routing in the LUT.

8. The method of claim 7 wherein the LUT is programmable.

9. The method of claim 6 wherein the LUT is based on a physical layout of the plurality of tiles.

10. The method of claim 1 wherein the first routing and the second routing are based on a dynamic routing algorithm.

11. The method of claim 10 wherein the dynamic routing algorithm is based on one or more quality of service (QoS) agents.

12. The method of claim 1 wherein the determining is accomplished by a mesh switching unit (MSU).

13. The method of claim 1 wherein the network is within a system-on-chip (SoC).

14. The method of claim 13 wherein the network comprises a network-on-chip (NOC), wherein the NOC includes an M×N mesh topology, wherein the M×N mesh topology includes a tile at each point of the M×N mesh topology.

15. The method of claim 14 wherein each tile in the plurality of tiles is coherent.

16. The method of claim 14 wherein at least one tile in the plurality of tiles includes a cache coherency block (CCB).

17. The method of claim 1 further comprising deciding, by the first intermediate tile, a third routing, wherein the third routing is based on a third intermediate tile within the plurality of tiles.

18. The method of claim 17 further comprising transferring, by the first intermediate tile, to the second intermediate tile, the communication packet, wherein the sending includes the third routing.

19. The method of claim 1 wherein the second intermediate tile comprises the target tile.

20. A computer program product embodied in a non-transitory computer readable medium for instruction execution, the computer program product comprising code which causes one or more processors to generate semiconductor logic for:
accessing a network, wherein the network comprises a plurality of tiles, wherein each tile in the plurality of tiles includes a mesh switching unit;
receiving, by a first tile within the plurality of tiles, a communication packet, wherein the communication packet specifies a target tile within the network, wherein the first tile and the target tile are not adjacent within the network, and wherein the communication packet includes a first routing, wherein the first routing includes a first intermediate tile within the plurality of tiles;
determining, by the first tile, a second routing, wherein the second routing is based on a second intermediate tile within the plurality of tiles; and
sending, by the first tile, to the first intermediate tile, the communication packet, wherein the sending includes the second routing.

21. A computer system for instruction execution comprising:
a memory which stores instructions;
one or more processors coupled to the memory, wherein the one or more processors, when executing the instructions which are stored, are configured to:
access a network, wherein the network comprises a plurality of tiles, wherein each tile in the plurality of tiles includes a mesh switching unit;
receive, by a first tile within the plurality of tiles, a communication packet, wherein the communication packet specifies a target tile within the network, wherein the first tile and the target tile are not adjacent within the network, and wherein the communication packet includes a first routing, wherein the first routing includes a first intermediate tile within the plurality of tiles;
determine, by the first tile, a second routing, wherein the second routing is based on a second intermediate tile within the plurality of tiles; and
send, by the first tile, to the first intermediate tile, the communication packet, wherein the sending includes the second routing.
